(19) United States
(12) Patent Application Publication
(10) Pub. No.: US 2003/0163785 A1
(43) Pub. Date: Aug. 28, 2003

(54) Composing unique document layout for document differentiation

(76) Inventors: Hui Chao, San Jose, CA (US); Henry W. Sang JR., Cupertino, CA (US)

Correspondence Address: HEWLETT-PACKARD COMPANY, Intellectual Property Administration, P.O. Box 272400, Fort Collins, CO, 80527-2400, US

(21) Appl. No.: 10/085,269

(22) Filed: Feb. 28, 2002

(51) Int. Cl. G06F 17/21

(52) U.S. Cl. 715/517

(57) ABSTRACT

A computer-implemented document composition device includes a processor and a memory communicating with the processor. The memory includes a document storage area storing one or more electronic documents and a distance modifier routine. The processor uses the distance modifier routine to modify a separation distance between two particular text clusters in the electronic document. A document thus differentiated may be easily discriminated from other, similar documents. The differentiation may result in a human eye insignificant difference to the document layout that may be computer recognizable.

### FIELD OF THE INVENTION

The present invention relates generally to document layout, and more particularly to document layout composition differentiation.

### BACKGROUND OF THE INVENTION

An electronic document is an electronically generated and stored file comprising text and/or graphics. For example, the document may be a homework document or a question/answer type document sheet, including paragraphs of instructions and questions followed by white spaces for recording answers. Alternatively, the document may include other text and/or graphics arrangements.

A completed electronic document may be stored and may be further processed at a later time. Because most documents are composed of blocks of text, such as paragraphs, one type of further processing may be a comparison between corresponding blocks of text of documents, such as an electronic sorting operation employing some manner of computerized discriminating device. The comparison may classify electronic documents into different groups, classes, types, etc.

In the prior art, document differentiation is typically done by adding bar codes, document numbers, or other codes to a document in order to differentiate a document from other documents. The disadvantage of such techniques is that they may disturb the overall appearance of the document. In addition, printed coding may be easily destroyed by accidentally writing on it.

In the prior art a comparison of gross features in an electronic document may be performed in order to determine whether the documents are the same. This typically includes operations such as comparison of text blocks and white space between blocks.

However, comparison of two documents based on text may be difficult, as font sizes and spacings are fairly standard. The result is that electronic documents are highly regular with respect to size and spacing and the only dimension that varies noticeably may be the number of lines in a paragraph. As a result, two unique documents may be separated by the same amount of white space and may include similarly sized paragraphs. Consequently, two unique and different documents may have the same number of paragraphs separated by the same amount of white space, and may include the same number of lines and columns. This makes automatic, computerized document discrimination based on a layout comparison very challenging and inaccurate.

Therefore, there remains a need in the art for improvements in document layout composition for the purpose of differentiation.

### SUMMARY OF THE INVENTION

A computer-implemented document composition device comprises a processor and a memory communicating with the processor. The memory includes a document storage area storing one or more electronic documents and a distance modifier routine. The processor uses the distance modifier routine to modify a separation distance between two particular text clusters in the electronic document.

### BRIEF DESCRIPTION OF THE DRAWINGS

FIG. 1 is a schematic of a document composition device according to one embodiment of the invention;

FIG. 2 shows an overall layout of a Document 1 and a Document 2 that is a differentiated version of Document 1;

FIG. 3 shows a flowchart of a document layout composition method according to another embodiment of the invention; and

FIG. 4 shows a flowchart of a document layout composition method according to yet another embodiment of the invention.

### DETAILED DESCRIPTION

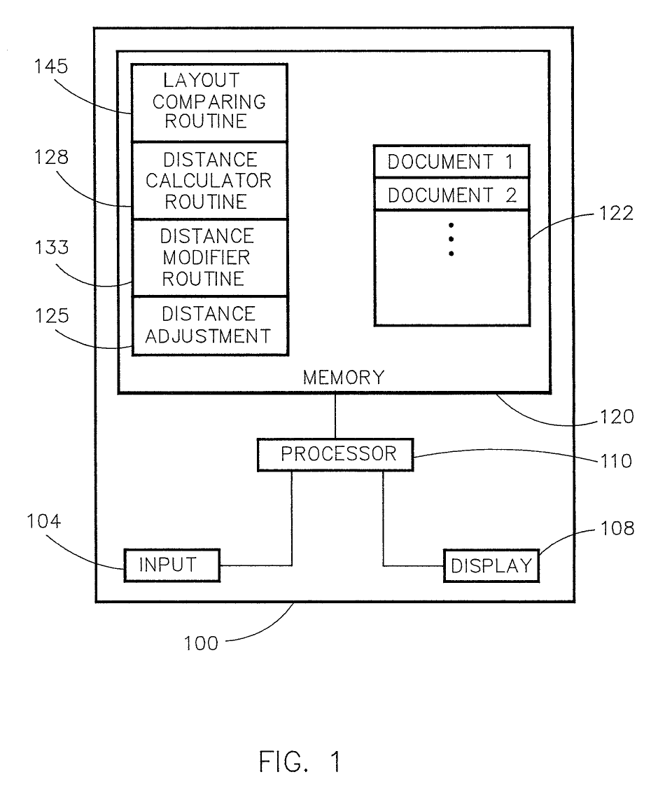

FIG. 1 is a schematic of a document composition device 100 according to one embodiment of the invention. The document composition device 100 may include an input device 104, a display device 108, a processor 110, and a memory 120.

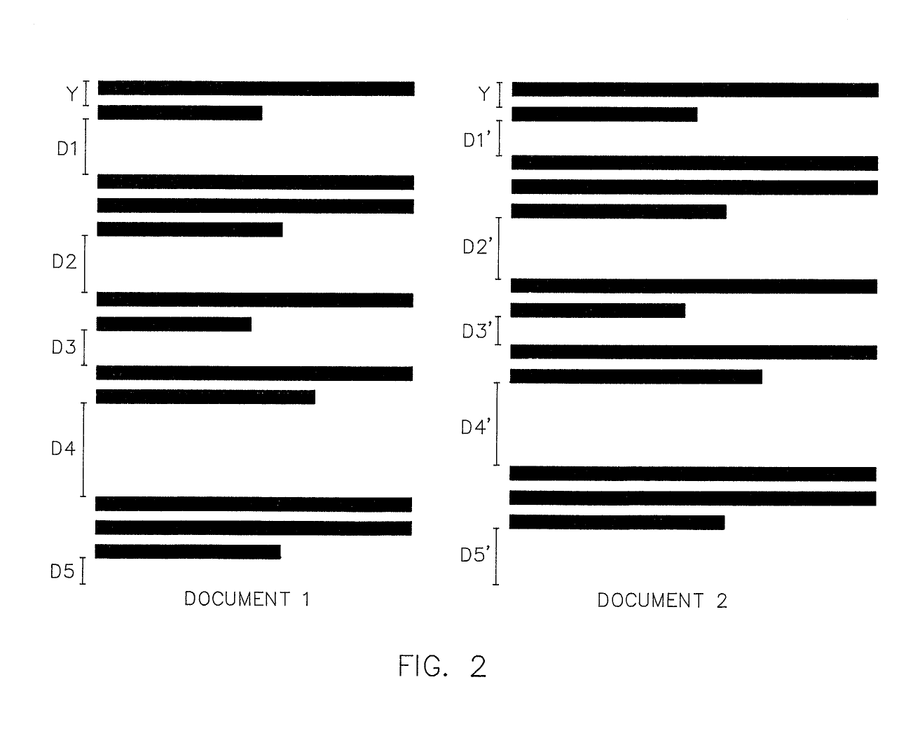

The document composition device 100 may be employed to modify a layout of a document. The document layout may be modified so that the document may be differentiated from other documents (see FIG. 2 and accompanying discussion). The layout difference may be small enough so that the differentiation is not easily noticeable to the human eye, but may be discriminated by a computer comparison of the documents. In cases where multiple, highly similar documents are created, the difference may be large enough to become visible to the human eye, although insignificant changes are generally preferred. One example is where multiple documents are created from a template, a form, or a master document.

The input device 104 may be any type of user input device, such as a keyboard, mouse, pointing device, touch screen, etc. The input device 104 may accept user inputs that designate an electronic document, create or modify an electronic document, select an electronic document for differentiation, etc. In addition, the input device 104 may be used to enable and disable a document layout differentiation mode.

The display device 108 may be any type of electronic display, such as a CRT screen, an LCD screen, etc. The display device 108 may display an electronic document to a user.

The processor 110 may be any type of general purpose processor. The processor 110 executes a control routine contained in the memory 120. In addition, the processor 110 receives inputs and performs a differentiation operation on a selected electronic document.

The memory 120 may be any type of digital memory. The memory 120 may include, among other things, a document storage area 122, a distance adjustment storage area 125, a distance calculator routine 128, a distance modifier routine 133, and a layout comparing routine 145. In addition, the memory 120 may store software or firmware to be executed by the processor 110.

The document storage area 122 may store one or more electronic documents. The documents may be in any stage of composition, and may be composed according to varying layouts. Although the document storage 122 is shown as an internal memory, it should be understood that the document storage 122 may be any manner of memory, including external memory, solid state memory, removable memory media, a storage such as a database, etc.

The distance adjustment storage area 125 stores a distance adjustment X. The distance adjustment X controls the amount of change to the separation distance D (i.e., a white space) during a differentiation operation. The distance adjustment X may be fixed or varying, and may optionally be user-settable.

The distance calculator routine 128 calculates the separation distance D between text clusters. A text cluster may be a text block, a text paragraph, or a text line, for example. Therefore, the distance calculator routine 128 calculates the sizes of white spaces {D1, D2, . . . . Dn} between text clusters.

The distance modifier routine 133 modifies the separation distance D between text clusters, for example by using the distance adjustment X. Therefore, the distance modifier routine 133 modifies a selected white space.

The layout comparing routine 145 is an optional routine that compares layouts between two documents. The layout comparing routine 145 generates an identical document layout output if the two documents have the same layout, and generates a non-identical document layout output if the two documents contain a computer-discernable difference. The layout comparing routine 145 therefore may be used to ensure that a particular document is differentiated from other documents. For example, the layout comparing routine 145 may be employed to compare a newly created document to a plurality of stored, pre-existing documents. In one embodiment of the invention, the layout comparing routine 145 may compare the new document to pre-existing documents stored in a database, for example.

The document layout differentiation may be performed during document composition. Alternatively, the differentiation may be performed on a completed document at any time after the electronic document has been created. The differentiation may additionally be performed on a scanned document that has been saved as an image.

In one embodiment, when a new document is created it may be automatically differentiated according to the invention. This may be done in circumstances where new documents are highly likely to be similar to pre-existing documents, such as when a master document or document template is used to produce multiple derivative documents.

In another embodiment, the user of the document composition device 100 may enable or disable the differentiation operation, i.e., the user may choose whether to perform a differentiation operation on a particular document. This may include differentiating newly created documents and differentiating pre-existing documents.

In yet another embodiment, when a new document is created, the new document is checked against documents stored in the document storage 122. If a document with the same layout does not exist, the new document is not modified. However, if a document with the same layout already exists, the new document may be modified in order to differentiate the new document from existing documents.

FIG. 2 shows an overall layout of a Document 1 and a Document 2 that is a differentiated version of Document 1. For example, Document 1 may be a homework answer sheet, including printed text clusters for questions followed by answer area white spaces. The answer area white spaces may be later filled in by handwritten answers, for example. Each document includes five text clusters (i.e., paragraphs or blocks of text) and associated separation distances/white spaces D1, D2, etc. The figure also shows the text line spacing Y, with the text line spacing Y comprising a text line height plus a line spacing.

In the example shown, Document 2 has been differentiated from Document 1 according to the invention. In the figure, the layout of Document 2 is identical to Document 1, except for the size of the white spaces (i.e., Document 2 has been differentiated from Document 1). The white space D1 of Document 1 is larger than the white space D1′ of Document 2. Likewise, the white space D5′ of Document 2 is larger than the corresponding white space D5 of Document 1. As a result, a computerized document comparison may easily distinguish Document 2 from Document 1. In addition, a Document 3 (not shown) could also be created by modifying another selection of white spaces in Document 1 to create another unique document with respect to both Document 1 and Document 2.

A white space may be changed by a distance adjustment X. The distance adjustment X may be any desired value, and may optionally be user-settable. The distance adjustment X may be a constant amount. Alternatively, the distance adjustment X may vary. For example, the distance adjustment X may be incremented or decremented at each distance modification iteration. Alternatively, the distance adjustment X may be a random amount, generated as a random or pseudo random number.

In one embodiment, the minimum amount or increment of distance adjustment X may be a distance equal to one text line. In another embodiment, the distance adjustment X must fall within the range of Y to 2*Y. In yet another embodiment, the distance adjustment X may be obtained from a set of training documents. Therefore, during design, a document composition device 100 may be subjected to a reasonable level of background noise (i.e., unfiltered handwriting or misleading signals or factors, such as markings outside of the text clusters, for example) and a minimum amount of layout change may be empirically determined. As a result, the user can be confident that a differentiated document can be reliably discriminated from other documents, even when the difference is insignificant to the human eye.

A general format for generating a document of a different layout is to modify the white spaces by a distance adjustment X, where:

X=f*Y (1)

The term f is a predetermined constant, and the text line spacing Y comprises a text line height plus a line spacing. This formula maintains a constant white space sum (i.e., the overall size of the document is not changed).

The overall document size may be maintained by performing symmetric changes to pairs of white spaces, i.e., add the distance adjustment X to one white space Di and subtract it from another white space Dj (assuming the changes meet any limit checks). This may yield:

$$\begin{matrix}{D}_{1} = {D}_{1} + {f}_{1} * Y & ( or {D}_{1} = {D}_{1} + {X}_{1} ) \\ {D}_{2} = {D}_{2} + {f}_{2} * Y & ( or {D}_{2} = {D}_{2} + {X}_{2} ) \\ \vert & \\ {D}_{n} = {D}_{n} + {f}_{n} * Y & ( or {D}_{n} = {D}_{n} + {X}_{n} )\end{matrix}$$

where

f₁*Y+f₂*Y+ . . . +fₙ*Y=0

In order to prevent anomalous results, the modified white spaces should be greater than the text line spacing Y in order to maintain a proper text cluster separation. The modified white space should also be large enough for the intended application, i.e., leaving enough answering area in an answer sheet embodiment. For example, the size of the answer area may be maintained to be larger than a desired minimum size by at least the text line spacing Y.

One simple layout differentiation example is a modification of the first and last white spaces by a distance adjustment X that is equal to the text line spacing Y. Therefore, the predetermined constant f may be f₁=1 and fₙ=−1.0. As a result, the modified layout will have white spaces of D₁+Y, D₂, D₃, D₄, . . . Dₙ−Y (note that only D₁ and Dₙ are modified by the text line spacing Y in this example).

In one differentiation embodiment, the document differentiating device 100 first locates and measures all of the white spaces in the document. A predetermined number of white spaces are selected for differentiation. In this example, two white spaces Di and Dj are selected for differentiation. The selected white spaces may be limit checked to ensure that they are capable of being modified. In one embodiment, the white spaces to be modified must be larger than 2*f*Y to allow a decremental modification such as Di=fᵢ*Y (assuming that fᵢ is positive), where the text line spacing Y is the text line height plus the spacing between lines and f may be a predetermined constant. If the white spaces to be modified are smaller than 2*f*Y, then only incremental modification may be allowed. The selected white spaces are modified by increasing Di by the distance adjustment X (new Di=Di+X) and decreasing Dj by X (new Dj=Dj−X) to create a new document layout. Alternatively, where Di and Dj are line pitch values, they may be simply incremented or decremented by the modification process.

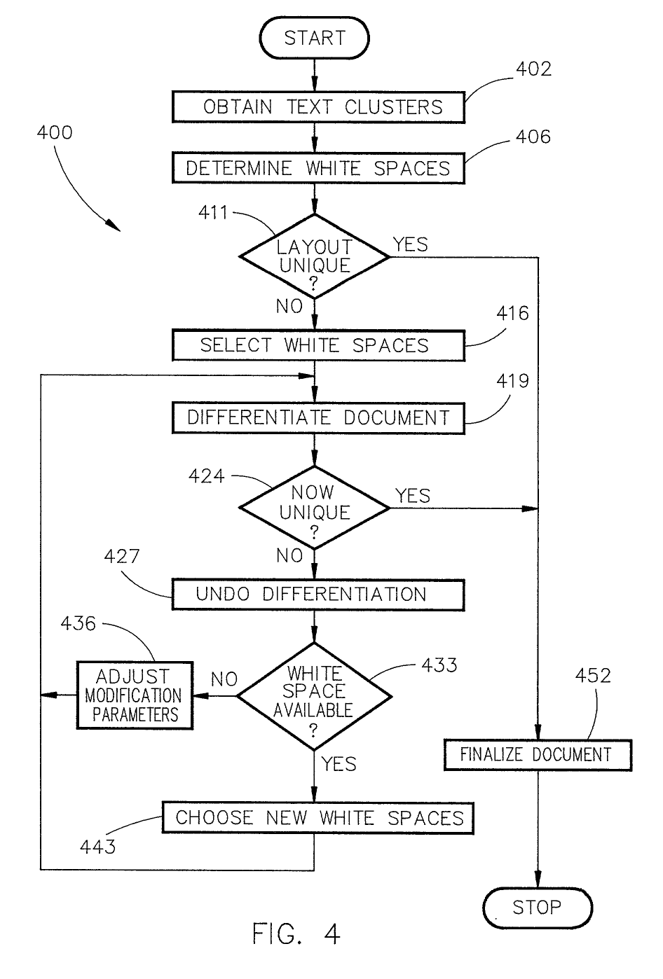

After the differentiation process has been completed, the modified (i.e., differentiated) document may be again compared to the documents stored in the document storage 122. The recomparison is desirable in order to ensure that the modified document does not match any of the pre-existing documents. However, if a match between the new but differentiated document and the pre-existing documents is found, the document composition device 100 may restore the original layout and modify one or more additional white spaces (see FIG. 4 and accompanying discussion).

In a document there may be N number of white spaces. Of the N number of white spaces, M number of white spaces may be larger than 2*Y and N−M number of white spaces may be smaller than 2*Y (where Y is the text line spacing). The number of unique layouts L that can be created by differentiation, if choosing to decrement and increment one pair of white spaces by a fixed value of X, is:

L=M*(M−1)+(N−M)*M (2)

In one example, the document to be differentiated includes four white spaces D1, D2, D3 and D4, thus N=4. The size of the white spaces D1, D3, and D4 are greater than or equal to 2*Y, and therefore M=3 (i.e., M=white spaces large enough to be modified). The size of the white space D2 is smaller than 2*Y. For this example, the number of possible layout combinations is L=3*(3−1)+(4−3)*3=3*2+1*3=6+3=9, assuming the white space is modified by the distance adjustment X=fᵢ*Y for Dᵢ (where the predetermined constant f is a value of 1.0 in this example). One set of possible combinations is:

(D1+Y), D2, D3, (D4−Y);

(D1+Y), D2, (D3−Y), D4;

(D1−Y), D2, (D3+Y), D4;

(D1−Y), D2, D3, (D4+Y);

D1, D2, (D3+Y), (D4−Y);

D1, D2, (D3−Y), (D4+Y);

D1−Y, D2+Y, D3, D4;

D1, D2+Y, D3−1, D4;

D1, D2+Y, D3, D4−1.

It should be understood that the above listing is just one possible set of modifications to white spaces. It should be noted that the number of possible layout combinations may be altered by changing the predetermined constant f. For example, more layout combinations are possible if the predetermined constant f=0.5.

A special case exists when the document to be differentiated contains only two text clusters or paragraphs. Instead of modifying the white space, the differentiation may alternatively modify the text line spacing Y. One example may be the modification of the line spacing by one-half of the current line spacing, such as by changing a single-spaced line to be one-half spaced or one-and-a-half spaced line.

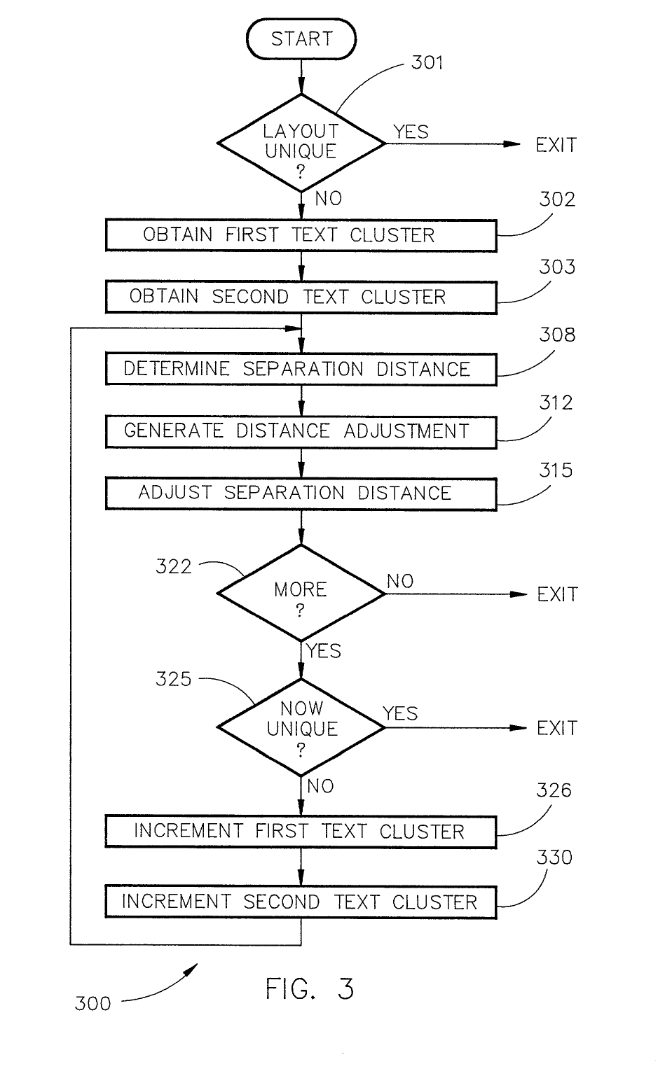

FIG. 3 shows a flowchart 300 of a document layout composition method according to another embodiment of the invention. In step 301, the system will check to see if the document layout is unique. This is done by comparing the document to other, pre-existing documents. If the document is unique, the method exits; otherwise it proceeds to step 302.

In step 302, a first text cluster is obtained from the digital document. The first text cluster may be any text cluster in the document.

In step 303, a second text cluster is obtained from the digital document. The second text cluster may be the text cluster hierarchically below the first text cluster. Alternatively, the second text cluster may be any other text cluster in the document.

In step 308, a separation distance D between the first and second text cluster is determined. This may be done, for example, by determining the number of blank lines between the two text clusters. In addition, the separation distance D may be checked to ensure that it falls within a modifiable range (i.e., the separation distance D may be left unchanged if it is too small or too large).

In step 312, a distance adjustment X is generated. In one embodiment, the differentiation may entail modifying the separation distance D by a fixed distance adjustment X. Alternatively, in another embodiment a random distance adjustment X may be generated. In another alternative, the distance adjustment X may be incremented or decremented with each distance modification iteration. In one embodiment, the distance adjustment X may fall within the range of 0.5*Y to 1.5*Y. However, other ranges may be employed.

In step 315, the separation distance D is adjusted by the distance adjustment X. For example, the separation distance D may be altered by adding or subtracting the distance adjustment X.

In addition, an optional limit check may be performed on the adjusted separation distance, such as comparing the new separation distance D to some manner of threshold. For example, in one embodiment the new separation distance D may have to be greater than or equal to 3*Y if the digital document includes an answer area for answering a question.

In step 322, the method determines whether there are more text clusters to be processed. Any number of text clusters may be differentiated according to the invention. For example, the distance between every other text cluster may be modified, or alternatively only a predetermined number may be modified. For example, it may be sufficient to modify only one separation distance in order to differentiate the document. If more text clusters are to be processed, the method proceeds to step 325; otherwise the method exits.

In step 325, the document may be tested to see if it is unique. This may include comparing the document to other documents. If the document is now unique, the method may exit; otherwise it proceeds to step 326.

In step 326, the first text cluster is incremented, wherein the first text cluster may be incremented to be a text cluster hierarchically after the current text cluster (i.e., the first text cluster may now be the third text cluster of the document). Alternatively, the new first text cluster may be randomly selected or may be selected according to any manner of selection pattern.

In step 330, the second text cluster is likewise incremented to become the fourth text cluster (or the sixth, eighth, etc.). Then the method loops back to step 308 and processes the current first and second text clusters. The processing and looping may be iteratively repeated until a desired number of white spaces have been modified or until the document has been successfully differentiated.

The document layout differentiation may advantageously apply to scanned documents for purposes of document sorting and registration. Therefore, a document that has been printed out, has received handwriting on white spaces, has been scanned back into an electronic document, and processed by a handwriting removal filter may still be successfully and accurately registered and sorted even if some noise affects the process. The differentiation may produce accurate and reliable results even if the resulting scanned and processed document includes a reasonable amount of added background noise (i.e., such as handwriting marks remaining in the answering area, etc.). The difference between such scanned documents is still significant enough so that a computerized document comparison routine may match and register the scanned document to a corresponding original document.

FIG. 4 shows a flowchart 400 of a document layout composition method according to yet another embodiment of the invention. In step 402, all text clusters of the electronic document are determined and obtained.

In step 406, all white spaces are determined. This includes determining the original sizes of the white spaces (i.e., the separation distances D1, D2, etc.). In addition, the separation distance D may be checked to ensure that it falls within a modifiable range.

In step 411, the electronic document may be tested to see if it is unique by comparing it to one or more pre-existing documents. The pre-existing documents may be stored in some form of memory, including in a database, for example. Alternatively, the pre-existing documents may be remotely located, and may be obtained for purposes of comparison. In this embodiment, the comparison is performed in order to determine whether the current electronic document needs to be differentiated. If the document matches one of the stored documents (i.e., an identical document already exists and the layout is not unique), then the method proceeds to step 416; otherwise it branches to step 452.

In step 416, one or more white spaces may be selected for modification as part of the differentiation. For example, two white spaces may be chosen from among the white spaces present in the electronic document. The white spaces may be selected at random, may be selected according to a predetermined pattern, may be sequentially selected and processed, may be selected and processed in an alternating fashion, etc.

In step 419, the selected one or more white spaces are modified. The modification may include modifying the current separation distance by a distance adjustment X, as previously discussed.

In step 424, the modified (differentiated) document is again compared to the stored documents to see if it is unique. If the document does not already exist, the method branches to step 452; otherwise it proceeds to step 427.

In step 427, because the differentiated document matches a stored document, the differentiation has failed to produce a unique document. Therefore, the differentiation must be undone and redone, such as with a modification to a different white space or spaces, or with a new distance adjustment to the currently selected white space. Consequently, in this step the previously performed differentiation is undone, and the original white space is restored.

In step 433, the method determines whether a new white space or white spaces may be differentiated, i.e., determines whether there are any remaining white spaces that have not been processed. If there are no available white spaces, the method branches to step 436; otherwise it proceeds to step 443.

In step 436, because there are no available white spaces, one or more modification parameters are adjusted in order to create a new set of modification parameters. In one embodiment, this may include selecting a new distance adjustment X. For example, the size of the predetermined constant f may be changed, such as from a value of 1.0 to 0.5. Alternatively, in another embodiment the number of selected white spaces to be modified is changed. For example, if modifying 2 white spaces does not produce a unique document, the method may switch to modifying 3 or more white spaces of the document. After the modification parameters are adjusted, the method may loop back to step 419 and re-differentiate the document using the new modification parameters in order to create another new layout of the document.

In step 443, one or more new white spaces are selected. Therefore, if a differentiation of a first white space selection does not produce a unique document, other white spaces may be selected and tried. After the new white spaces are selected, the method may loop back to step 419 and re-differentiate the document using the newly selected white space or spaces.

In step 452, the document has been determined to be successfully differentiated from the stored documents, and therefore the electronic document is finalized. This includes retaining the document layout modifications made during the differentiation process.

The document layout composition differentiation according to the invention may be performed by any computerized document device, such as personal computers, network work stations, laptops, personal digital assistants (PDAs), etc.

The invention differs from the prior art in that the invention modifies a document layout in order to differentiate the document. The differentiation may be desirable in document processing operations such as document sorting and registration. This may be done in order to make comparisons between documents easier and make comparison results more predictable.

The invention provides several benefits. The document layout differentiation may produce a computer detectable layout difference, but with the difference being insignificant to the human eye. A computerized document comparison routine therefore can compare two digital documents that have been differentiated according to the invention and may easily and accurately discriminate between documents.

We claim:

1. A document composition device, comprising:
a processor; and
a memory communicating with said processor and including a document storage area storing one or more electronic documents and a distance modifier routine, with said processor using said distance modifier routine to modify a separation distance between two particular text clusters in said electronic document.

2. The device of claim 1, wherein said two particular text clusters comprise two or more text blocks.

3. The device of claim 1, wherein said two particular text clusters comprise two or more text paragraphs.

4. The device of claim 1, wherein said two particular text clusters comprise two or more text lines.

5. The device of claim 1, wherein said document storage area stores a plurality of electronic documents.

6. The device of claim 1, wherein said distance modifier routine modifies said separation distance by a predetermined distance adjustment.

7. The device of claim 1, with said memory further including a distance calculator routine that computes said separation distance.

8. The device of claim 1, with said memory further including a layout comparing routine that compares a selected document layout to one or more pre-existing documents and generates an identical document layout output if said selected document layout is identical to a pre-existing document.

9. A computer-implemented document layout composition method, comprising the steps of:
determining a separation distance between a first text cluster and a second text cluster of an electronic document;
generating a distance adjustment; and
adjusting said separation distance of said electronic document by said distance adjustment.

10. The method of claim 9, wherein the determining, generating, and adjusting steps are performed for two or more text clusters in said electronic document.

11. The method of claim 9, wherein the determining, generating, and adjusting steps are iteratively performed.

12. The method of claim 9, wherein the adjusting step comprises adding said distance adjustment to said separation distance.

13. The method of claim 9, wherein the adjusting step comprises subtracting said distance adjustment from said separation distance.

14. The method of claim 9, further comprising the step of determining whether said separation distance falls within a modifiable range.

15. The method of claim 9, wherein each of said first text cluster and second text cluster are single text lines.

16. The method of claim 9, wherein said distance adjustment must be larger than a text line spacing and less than twice said text line spacing.

17. The method of claim 9, further comprising the preliminary step of comparing a layout of said electronic document to one or more pre-existing electronic documents, wherein the determining, generating, and adjusting steps are performed if said layout is identical to a pre-existing electronic document.

18. The method of claim 17, further comprising the steps of:
comparing a new layout of said electronic document to said one or more pre-existing documents;
undoing the adjusting step if said new layout is identical to a pre-existing electronic document;
changing one or more modification parameters to form a new set of modification parameters if said new layout is identical to a pre-existing electronic document; and
repeating the determining, generating, and adjusting steps using said new set of modification parameters to create another new layout of said electronic document if said new layout is identical to a pre-existing electronic document.

19. A computer-implemented document layout composition method, comprising the steps of:
comparing a layout of a particular electronic document to one or more pre-existing electronic documents;
modifying one or more separation distances between text clusters of said particular electronic document to create a differentiated electronic document if said layout of said particular electronic document matches a pre-existing electronic document;
comparing a layout of said modified electronic document to said layouts of said one or more pre-existing electronic documents;
undoing said modifying of said one or more separation distances of said particular electronic document if said layout of said modified electronic document matches a layout of another pre-existing electronic document;
changing one or more modification parameters to form a new set of modification parameters if said layout of said modified electronic document matches said layout of another pre-existing electronic document; and
repeating the step of modifying and the step of comparing said layout of said modified electronic document to said layouts of said one or more pre-existing electronic documents using said new set of modification parameters.

20. The method of claim 19, wherein the modifying step further comprises the steps of:
computing a separation distance between a first text cluster and a second text cluster of an electronic document;
generating a distance adjustment; and
adjusting said separation distance of said electronic document by said distance adjustment.

21. The method of claim 20, wherein the adjusting step comprises adding said distance adjustment to said separation distance.

22. The method of claim 20, wherein the adjusting step comprises subtracting said distance adjustment from said separation distance.

23. The method of claim 20, further comprising the step of determining Whether said separation distance falls within a modifiable range.

24. The method of claim 20, wherein said distance adjustment must be larger than a text line spacing and less than twice said text line spacing.
